(19) United States
(12) Patent Application Publication
(10) Pub. No.: US 2007/0229552 A1
(43) Pub. Date: Oct. 4, 2007

(54) Color compensation method for a display

(75) Inventors: Hung-Min Shih, Hsin-Chu (TW); Chung-Kuang Tsai, Hsin-Chu (TW); Kun-Hung Hsieh, Hsin-Chu (TW); Chih-Wei Chen, Hsin-Chu (TW); Chung-Lung Li, Hsin-Chu (TW)

Correspondence Address: RABIN & Berdo, PC, 1101 14TH STREET, NW, SUITE 500, WASHINGTON, DC, 20005, US

(73) Assignee: AU OPTRONICS CORP., Hsin-Chu (TW)

(21) Appl. No.: 11/806,144

(22) Filed: May 30, 2007

Related U.S. Application Data
(63) Continuation-in-part of application No. 11/137,434, filed on May 26, 2005.

(30) Foreign Application Priority Data
Dec. 26, 2004 (TW) TW 93136635

(51) Int. Cl. G09G 5/10

(52) U.S. Cl. 345/690

(57) ABSTRACT

A color compensation method for a display is disclosed. The display includes a display module for receiving a plurality of original pixel data. The method includes calculating power-on time duration of the display module; and adjusting gray levels of the original pixel data according to the power-on time duration.

This application claims the benefit of Taiwan Patent Application Serial No. 93136635, filed Nov. 26, 2004, the subject matter of which is incorporated herein by reference.

### BACKGROUND OF THE INVENTION

1. Field of the Invention

The invention relates in general to a color compensation method for a display, and more particularly to a color compensation method for a non-self-illumination display.

2. Description of the Related Art

Referring to FIG. 1, a block diagram of a conventional liquid crystal display (LCD) is shown. The LCD. 100 includes a control circuit 110 and a display module 120. The control circuit 110 includes a timing controller 112 and the display module 120 includes a data driver 122, a display panel 124 and a scan driver 126. The data driver 122 outputs data voltages to the display panel 124 according to the pixel data Dp and the clock signal CLK output by the timing controller 112. The scan driver 126 actuates pixel control switches raw by raw to display the corresponding images on the display panel 124 according to the gate IC clock signal output by the timing controller 112.

The lifetime of present display panels 124 is demanded at least 50,000 hours to 60,000 hours. However, for plastic thin-film part of the display module 120, such as a backlight module and a polarizing plate, is easily damaged as used for a long time, the aging (yellowness) effect occurs on the display module 120 and influences the gray level display of the display panel 124. As a result, the lifetime of the LCD 100 is reduced.

### SUMMARY OF THE INVENTION

It is therefore an object of the invention to provide a color compensation method for a display. According to the using time of a display module of the display, a spontaneous color compensation is performed to prevent the above-mentioned aging effect occurred as the display panel is used for a long time and thus elongate lifetime of the display.

The invention achieves the above-identified object by providing a color compensation method for a display. The display includes a display module for receiving a plurality of original pixel data. The method includes calculating power-on time duration of the display module; and adjusting red gray levels and blue gray levels of the original pixel data according to the power-on time duration.

The invention achieves the above-identified object by providing a color compensation method for a display. The display includes a display module for receiving a plurality of original pixel data. The method includes calculating power-on time duration of the display module; and adjusting red gray levels and green gray levels of the original pixel data according to the power-on time duration.

The invention achieves the above-identified object by providing a color compensation method for a display. The display includes a display module for receiving a plurality of original pixel data. The method includes calculating power-on time duration of the display module; and simultaneously adjusting red gray levels, green gray levels and blue gray levels of the original pixel data according to the power-on time duration.

The invention achieves the above-identified object by providing a color compensation method for a display. The display includes a display module for receiving a plurality of original pixel data. The method includes calculating power-on time duration of the display module; and adjusting green gray levels and blue gray levels of the original pixel data according to the power-on time duration.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a block diagram of a conventional LCD.

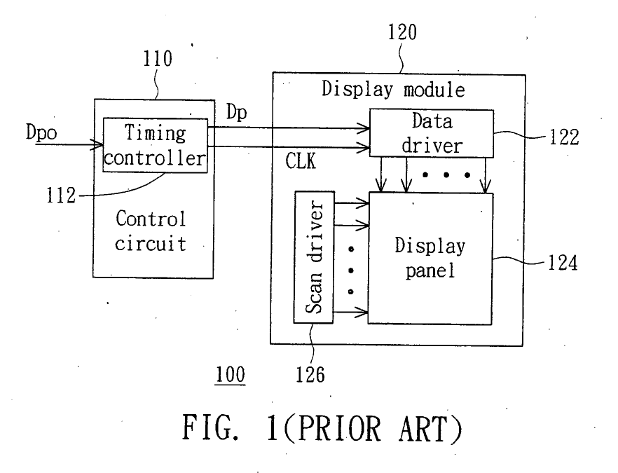

FIG. 2 is a flow chart of a color compensation method for a LCD according to the first embodiment of the invention.

FIG. 3 is a flow chart of a color compensation method for a LCD according to the second embodiment of the invention.

FIG. 4 is a flow chart of a color compensation method for a LCD according to the third embodiment of the invention.

FIG. 5 is a flow chart of a color compensation method for a LCD according to the fourth embodiment of the invention.

### DETAILED DESCRIPTION OF THE INVENTION

### Embodiment One

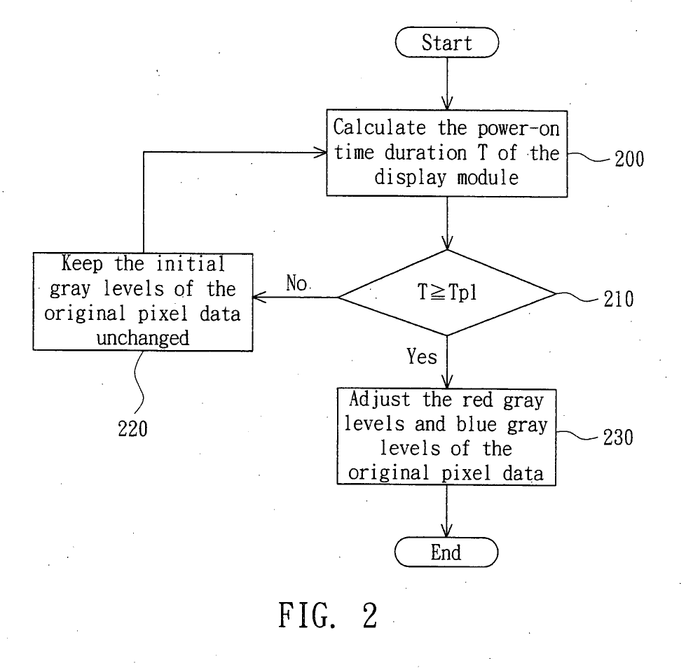

Referring to FIG. 2, a flow chart of color compensation method for a LCD according to the first embodiment of the invention is shown. The LCD includes a display module for receiving a number of original pixel data. First in step 200, calculate the power-on time duration T of the display module by using a timer. Afterwards, in step 210, determine whether the power-on time duration T reaches (is not smaller than) a predetermined value Tp1. If the power-on time duration T does not reach the predetermined value Tp1, continue to the step 220, in which the initial pixel levels of the original pixel data are kept unchanged, and then return to the step 200. For example, the LCD determines the initial pixel levels of the original pixel data by checking a first look-up table, with the red, green and blue gray levels 250, 250 and 250. In the step 220, the first look-up table is continuously checked to determine gray levels of the original pixel data.

If the power-on time duration T reaches the predetermined value Tp1, continue the step 230, in which the red gray levels and blue gray levels of the original pixel data are adjusted. For example, the first look-up table is checked to determine the initial gray levels (250, 250, 250) of the original pixel data, and in the step 230, a second look-up table with the red, green and blue gray levels, 245, 250 and 255, is checked to reduce the red gray levels and increase the blue gray levels of the original pixel data. By doing this, the yellowness issue of the LCD as used for a long time can be solved.

### Embodiment Two

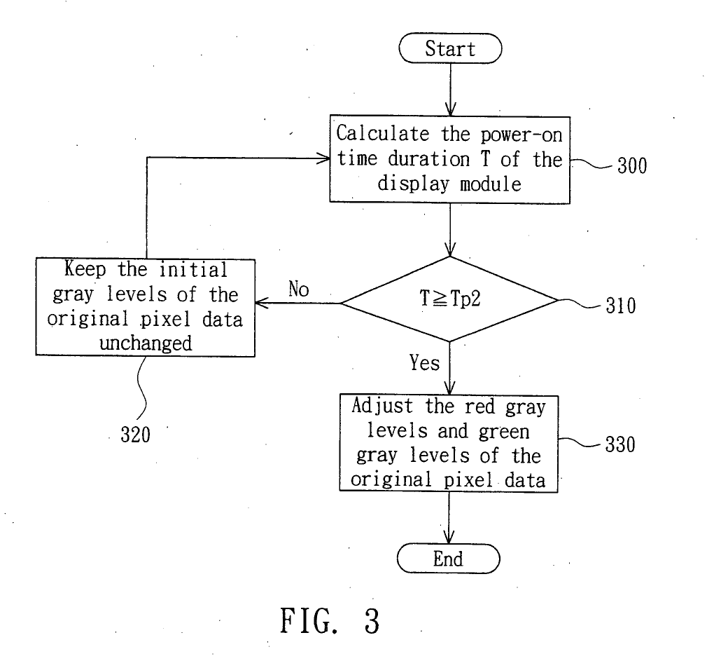

Referring to FIG. 3, a flow chart of color compensation method for a LCD according to the second embodiment of the invention is shown. The LCD includes a display module for receiving a number of original pixel data. First in step 300, calculate the power-on time duration T of the display module by using a timer. Afterwards, in step 310, determine whether the power-on time duration T reaches (is not smaller than) a predetermined value Tp2. If the power-on time duration T does not reach the predetermined value Tp2, continue to the step 320, in which the initial pixel levels of the original pixel data are kept unchanged, and then return to the step 300. For example, the LCD determines the initial pixel levels of the original pixel data by checking a first look-up table, with the red, green and blue gray levels 250, 250 and 250. In the step 320, the first look-up table is continuously checked to determine gray levels of the original pixel data.

If the power-on time duration T reaches the predetermined value Tp2, continue the step 330, in which the red gray levels and green gray levels of the original pixel data are adjusted. For example, the first look-up table is checked to determine the initial gray levels (250, 250, 250) of the original pixel data, and in the step 330, a second look-up table with the red, green and blue gray levels, 245, 245 and 250, is checked to reduce the red gray levels and reduce the green gray levels of the original pixel data. By doing this, the yellowness issue of the LCD as used for a long time can be solved.

### Embodiment Three

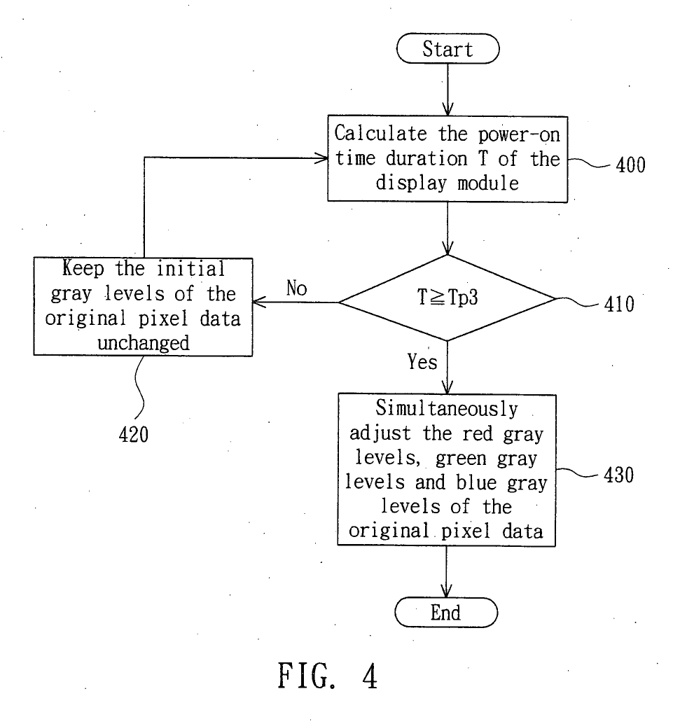

Referring to FIG. 4, a flow chart of color compensation method for a LCD according to the third embodiment of the invention is shown. The LCD includes a display module for receiving a number of original pixel data. First in step 400, calculate the power-on time duration T of the display module by using a timer. Afterwards, in step 410, determine whether the power-on time duration T reaches (is not smaller than) a predetermined value Tp3. If the power-on time duration T does not reach the predetermined value Tp3, continue to the step 420, in which the initial pixel levels of the original pixel data are kept unchanged, and then return to the step 400. For example, the LCD determines the initial pixel levels of the original pixel data by checking a first look-up table, with the red, green and blue gray levels 250, 250 and 250. In the step 420, the first look-up table is continuously checked to determine gray levels of the original pixel data.

If the power-on time duration T reaches the predetermined value Tp3, continue the step 430, in which the red gray levels, green gray levels and blue gray levels of the original pixel data are adjusted simultaneously. For example, the first look-up table is checked to determine the initial gray levels (250, 250, 250) of the original pixel data, and in the step 230, a second look-up table with the red, green and blue gray levels, 247, 247 and 255, is checked to increase the blue gray levels and reduce the green and red gray levels of the original pixel data. By doing this, the yellowness issue of the LCD as used for a long time can be solved.

### Embodiment Four

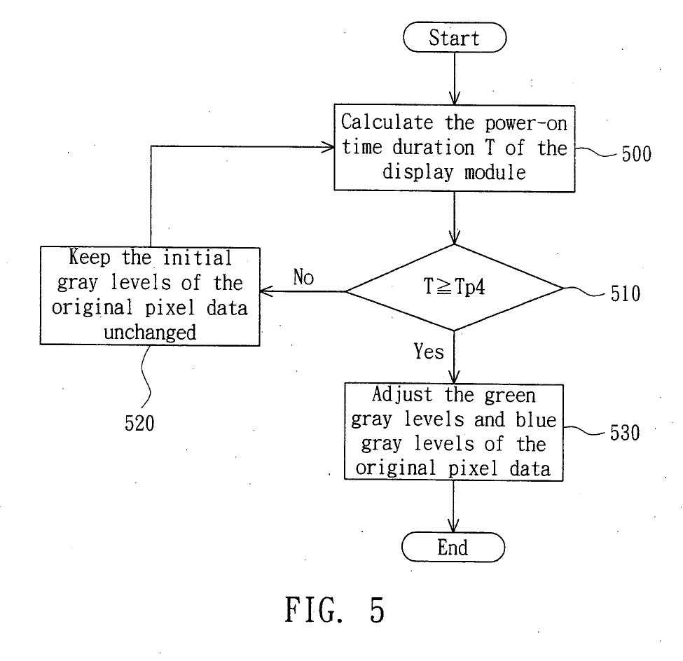

Referring to FIG. 5, a flow chart of color compensation method for a LCD according to the fourth embodiment of the invention is shown. The LCD includes a display module for receiving a number of original pixel data. First in step 500, calculate the power-on time duration T of the display module by using a timer. Afterwards, in step 510, determine whether the power-on time duration T reaches (is not smaller than) a predetermined value Tp4. If the power-on time duration T does not reach the predetermined value Tp4, continue to the step 520, in which the initial pixel levels of the original pixel data are kept unchanged, and then return to the step 500. For example, the LCD determines the initial pixel levels of the original pixel data by checking a first look-up table, with the red, green and blue gray levels 250, 250 and 250. In the step 520, the first look-up table is continuously checked to determine gray levels of the original pixel data.

If the power-on time duration T reaches the predetermined value Tp4, continue the step 530, in which the green gray levels and blue gray levels of the original pixel data are adjusted. For example, the first look-up table is checked to determine the initial gray levels (250, 250, 250) of the original pixel data, and in the step 530, a second look-up table with the red, green and blue gray levels, 250, 245 and 255, is checked to reduce the green gray levels and increase the blue gray levels of the original pixel data. By doing this, the yellowness issue of the LCD as used for a long time can be solved.

In the above-mentioned four embodiments, the pixel gray levels in the first look-up table or the second look-up table LUT2 can be adjusted according to the actual display panel yellowness (aging) situation, and the predetermined value Tp1, Tp2, Tp3 or Tp4 can also be adjusted. For example, the number of color-compensating periods can be increased (more than one) and different compensating gray levels in each period are used to dynamically compensate the original pixel data so as to maintain the normal color display of the LCD.

Although the LCD performing color compensation by checking the look-up tables is taken as an example in the invention, the color compensation method of the invention can also spontaneously compensate the original pixel data according to the power-on time duration of the display module by checking a time and color compensation table set in a timing controller by firmware, or even by other mathematical arithmetic methods. Since the gray levels of the original pixel data can be spontaneously calibrated to compensate the aging (yellowness) effect of the display module as the power-on time duration of the display reaches the predetermined value, it will not be apart from the skill scope of the invention.

According to the above-mentioned four embodiments, the color compensation method has the following advantages. By calculating the power-on time duration of the display module, the red, green and blue gray levels of the original pixel data can be dynamically compensated to maintain the normal color display of the display as it is used for a predetermined period of time. Therefore, the above-mentioned aging (yellowness) issue of the display can be solved and thus lifetime of the display can be elongated.

While the invention has been described by way of example and in terms of four embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A color compensation method for a display, the display comprising a display module for receiving a plurality of original pixel data, the method comprising:
(a) calculating power-on time duration of the display module; and
(b) adjusting red gray levels and blue gray levels of the original pixel data according to the power-on time duration.

2. The color compensations method according to claim 1, wherein the step (b) comprises reducing red gray levels and increasing blue gray levels of the original pixel data.

3. The color compensation method according to claim 1, wherein the step (b) comprises compensating the red gray levels and blue gray levels of the original pixel data by using a lookup table.

4. The color compensation method according to claim 3, wherein the step (b) comprises determining whether the power-on time duration reaches a predetermined value.

5. The color compensation method according to claim 4, wherein the red gray levels and the blue gray levels of the original data are compensated in accordance with a first look-up table if the power-on time duration does not reach the predetermined value.

6. The color compensation method according to claim 5, wherein the red gray levels and blue gray levels of the original data are compensated in accordance with a second look-up table if the power-on time duration reaches the predetermined value.

7. A color compensation method for a display, the display comprising a display module for receiving a plurality of original pixel data, the method comprising:
(a) calculating power-on time duration of the display module; and
(b) adjusting red gray levels and green gray levels of the original pixel data according to the power-on time duration.

8. The color compensation method according to claim 7, wherein the step (b) comprises reducing red gray levels and green gray levels of the original pixel data.

9. The color compensation method according to claim 7, wherein the step (b) comprises compensating the red gray levels and green gray levels of the original pixel data by using a lookup table.

10. The color compensation method according to claim 9, wherein the step (b) comprises determining whether the power-on time duration reaches a predetermined value.

11. The color compensation method according to claim 10, wherein the red gray levels and green gray levels of the original data are compensated in accordance with a first look-up table if the power-on time duration does not reach the predetermined value.

12. The color compensation method according to claim 11, wherein the red gray levels and green gray levels of the original data are compensated in accordance with a second look-up table if the power-on time duration reaches the predetermined value.

13. A color compensation method for a display, the display comprising a display module for receiving a plurality of original pixel data, the method comprising:
(a) calculating power-on time duration of the display module; and
(b) simultaneously adjusting red gray levels, green gray levels and blue gray levels of the original pixel data according to the power-on time duration.

14. The color compensation method according to claim 13, wherein the step (b) comprises increasing blue gray levels and reducing green gray levels and red gray levels of the original pixel data.

15. The color compensation method according to claim 13, wherein the step (b) comprises compensating the red gray levels, green gray levels and blue gray levels of the original pixel data by using a lookup table.

16. The color compensation method according to claim 15, wherein the step (b) comprises determining whether the power-on time duration reaches a predetermined value.

17. The color compensation method according to claim 16, wherein the red gray levels, green gray levels and blue gray levels of the original data are compensated in accordance with a first look-up table if the power-on time duration does not reach the predetermined value.

18. The color compensation method according to claim 17, wherein the red gray levels, green gray levels and blue gray levels of the original data are compensated in accordance with a second look-up table if the power-on time duration reaches the predetermined value.

19. A color compensation method for a display, the display comprising a display module for receiving a plurality of original pixel data, the method comprising:
(a) calculating power-on time duration of the display module; and
(b) adjusting green gray levels and blue gray levels of the original pixel data according to the power-on time duration.

20. The color compensation method according to claim 19, wherein the step (b) comprises reducing green gray levels and increasing blue gray levels of the original pixel data.

21. The color compensation method according to claim 19, wherein the step (b) comprises compensating the green gray levels and blue gray levels of the original pixel data by using a lookup table.

22. The color compensation method according to claim 21, wherein the step (b) comprises determining whether the power-on time duration reaches a predetermined value.

23. The color compensation method according to claim 22, wherein the green gray levels and blue gray levels of the original data are compensated in accordance with a first look-up table if the power-on time duration does not reach the predetermined value.

24. The color compensation method according to claim 23, wherein the green gray levels and blue gray levels of the original data are compensated in accordance with a second look-up table if the power-on time duration reaches the predetermined value.
